(19) United States
(12) Patent Application Publication
(10) Pub. No.: US 2017/0171368 A1
(43) Pub. Date: Jun. 15, 2017

(54) STACKABLE PERIPHERALS

(71) Applicant: Novatel Wireless, Inc., San Diego, CA (US)

(72) Inventors: Vishal Donthireddy, San Diego, CA (US); Stephen Sek, San Diego, CA (US); Peter Szucs, Los Angeles, CA (US); Charles Moore, Plano, TX (US); Todd Eugene Conklin, San Diego, CA (US); Preetha Thomas Alumootil, San Diego, CA (US); John Jun Wu, San Diego, CA (US)

(21) Appl. No.: 15/224,509

(22) Filed: Jul. 29, 2016

Related U.S. Application Data
(60) Provisional application No. 62/198,597, filed on Jul. 29, 2015.

(51) Int. Cl. H04M 1/02

(52) U.S. Cl. CPC H04M 1/026; H04M 1/0254; H04M 1/0272

(57) ABSTRACT

Stackable electronic devices are disclosed which can be stacked onto each other in such a manner that electrical contacts with one device mate with electronic contacts on other devices either above or below the device to create an electrical connection between the devices in the stack. Magnets or latches can be used to secure the stacked devices together. The contacts, as well as status indicators, are arranged in common locations on the devices and the devices can be capable of automatically configuring addressing, device capabilities, and wireless communication paths.

### TECHNICAL FIELD

The present invention relates generally to peripheral devices for a mobile hotspot product line. More specifically, the present invention relates to a family of stackable peripheral devices for a mobile hotspot device, including items like external batteries, projectors and speakers.

### BACKGROUND

A number of approaches have been considered for managing peripherals to mobile hotspot product lines. The most common approach requires either cables or manual configuration of wireless connectivity. A modular approach is desired, without cabling, with auto-discovery and configuration.

### SUMMARY

One embodiment of the invention includes a stackable set of peripherals, held together with magnetics and latches. A 6 pin connector providing power distribution and basic device setup capability can be used. The peripherals can have a common USB connector location and LED location and meaning. A basic configuration can allow for automatic configuration of addressing, discovery of device capability, and configuration of wireless communications paths. Wireless communications paths from the mobile hotspot to the peripheral can be automatically configured and can be used for all subsequent data transport. Embodiments can provide for centralized control by cellular access point, automatic device capability detection and communication establishment, configuration initiated on mating, maintained when unmated, enhanced power management, allowing for central control of charging mechanisms, centralized power management, allowing for dynamic allocation of charging resources. Embodiments may employ a power management process that may provide controlled power up, mobile hotspot control of power distribution, and local battery and external battery support. Embodiments may also provide automatic device detection and configuration, use of SMBus for address allocation, use of power pins to allow controlled power up, use of proprietary device information field to determine capabilities of peripherals, and use of proprietary device configuration fields for configuration of device capabilities (Bluetooth, WiFi, battery primarily). Embodiments may provide a protocol used in the configuration and management of a peripheral from a mobile hotspot where discovery is done through an ARP process. The capability of the peripheral may be provided in an extensible data string. Power charging can be independently enabled for each peripheral by the mobile hotspot or power charging may be automatically enabled in the absence of the mobile hotspot.

### BRIEF DESCRIPTION OF THE DRAWINGS

FIGS. 1A-1D illustrate an embodiment of the invention employing a pico projector for projecting images on a large surface;

FIG. 1E is a table that illustrates various features and accessories available for the different uses of embodiments of the invention;

FIGS. 2A-2B illustrate an embodiment of the invention employing a pico projector to allow media sharing by pushing the shared media to a pico projector;

FIGS. 3A-3C illustrate an embodiment of the invention employing a pico projector with a mobile app to allow users to use their mobile devices to interact with the app and to project the users' interaction;

FIGS. 4A-4E illustrate an embodiment of the invention employing a pico projector to allow users to create and project collaborative projects such as presentations;

FIGS. 5A-5B illustrate an embodiment of the invention employing a pico projector to electronically design different styles of makeup and to project the different makeup styles onto a person for previewing how the makeup style would look on the person;

FIGS. 6A-6D illustrate an embodiment of the invention employing a pico projector and mobile device to create an interactive whiteboard;

FIGS. 7A-7H illustrate various other embodiments of the invention employing pico projectors for various imaginative use cases;

FIGS. 8A-8D illustrate a stackable embodiment of the invention having a generally square shape;

FIGS. 9A-9B illustrate a stackable embodiment of the invention having a generally hexagonal shape;

FIG. 9C illustrates a stackable embodiment of the invention having a generally “donut” shape;

FIG. 9D illustrates a stackable embodiment of the invention having a generally square shape stacked in a staggered stack configuration;

FIGS. 10A-10B illustrate a stackable embodiment of the invention having a generally round shape;

FIGS. 11A-11D illustrate a disassembled stack of a stackable embodiment of the invention having a generally square shape;

FIGS. 12A-12D illustrate an alternative embodiment of the disassembled stack of FIGS. 11A-11D;

FIGS. 13A-13D illustrate another alternative embodiment of the disassembled stack of FIGS. 11A-11D;

FIGS. 14A-14E illustrate still another alternative embodiment of the disassembled stack of FIGS. 11A-11D;

FIGS. 15A-15C illustrate a disassembled stack of a stackable embodiment of the invention having a generally round shape;

FIGS. 15D-15G illustrate an alternative embodiment of the disassembled stack of FIGS. 11A-11D;

FIGS. 16A-16D illustrate another embodiment of the disassembled stack of FIGS. 11A-11D;

FIGS. 17A-17F illustrate an alternative embodiment of the disassembled stack of FIGS. 11A-11D;

FIG. 18A shows a top view of a stackable embodiment of the invention having a generally square shape;

FIG. 18B shows a bottom view of the stackable embodiment shown in FIG. 18A; and

FIG. 18C shows a side view of the stackable embodiment shown in FIG. 18A.

### DETAILED DESCRIPTION

Embodiments of the invention can include a number of use cases. These use cases can focus on an open development environment, allowing for innovative uses for projectors and speakers, and allowing for an interactive experience using existing handheld devices. The connectivity allowed through the stackable peripheral form factor and control protocol of various embodiments of the invention may enable a series of novel uses of a projector. These use cases address a number of current problems, including a variety of portable entertainment, educational, and medical use cases. For example, as illustrated in the Figures, possible use cases can include the extension of conventional projector scenarios, such as docking a projector to a mobile hotspot to configure connection, removing a projector from the mobile hotspot to locate in desired location, streaming data from a public WiFi network or a mobile hotspot based WiFi network. Embodiments may be useable in hotels, conferences, camping environments, medical environments, educational environments, or social events. Embodiments also provide media sharing applications such as sharing of media content, a smartphone based application may allow for distributed control and user initiated data distribution, embodiment may be useable in a classroom environment, with teacher controlling student access to a centralized projector and/or useable in collaborative design environments. Possible use of motion sensing or laser module technology may provide interactivity. Projection mapping applications may be included such as makeup application instructions and evaluation, providing GPS based directions for hiking, cycling, or other mobile applications, medical applications, allowing for better visualization to both patients and medical staff, gaming applications, allowing for artificial playing field to be projected on a surface, and/or food preparation, allowing for visualization of preparation activities.

Embodiments of the invention can include media playback that works across mobile device platforms (without cords), wireless screen sharing in a variety of different environments and operating systems, as well as wired connections that work with commonly available cables connecting components to a variety of different devices. Wireless audio can be enabled that provides a truly wireless home theater experience. Embodiments can include automatic configuration so that they “just work” straight out of the box without any complicated setup required by the user, by configuring the devices to automatically pair with other nearby wireless devices. Extended battery life can be achieved through energy conservation and distribution methods included in stackable device as well as through the use of extra batteries configured as stackable elements with other stackable embodiments of the invention.

One embodiment of the invention includes multiple elements which can perform different functions but which can interface and connect to each other either wirelessly or through stackable elements having similar form factors and common connectors and connector locations so that the stackable elements interconnect through the connectors in any order in which they are stacked. One embodiment of the invention can include a projector and speakers which automatically connect to and interact with a wireless hot spot or mobile device.

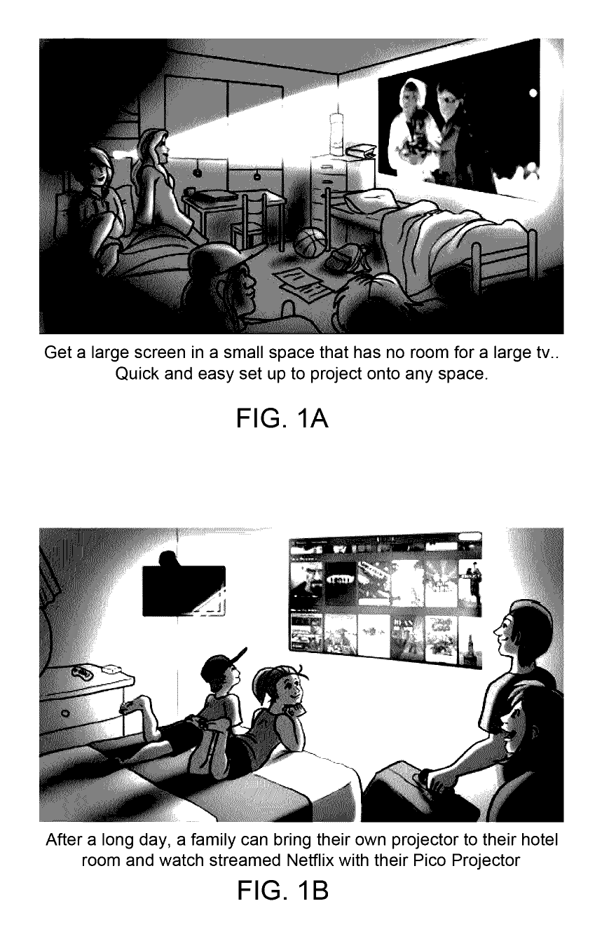

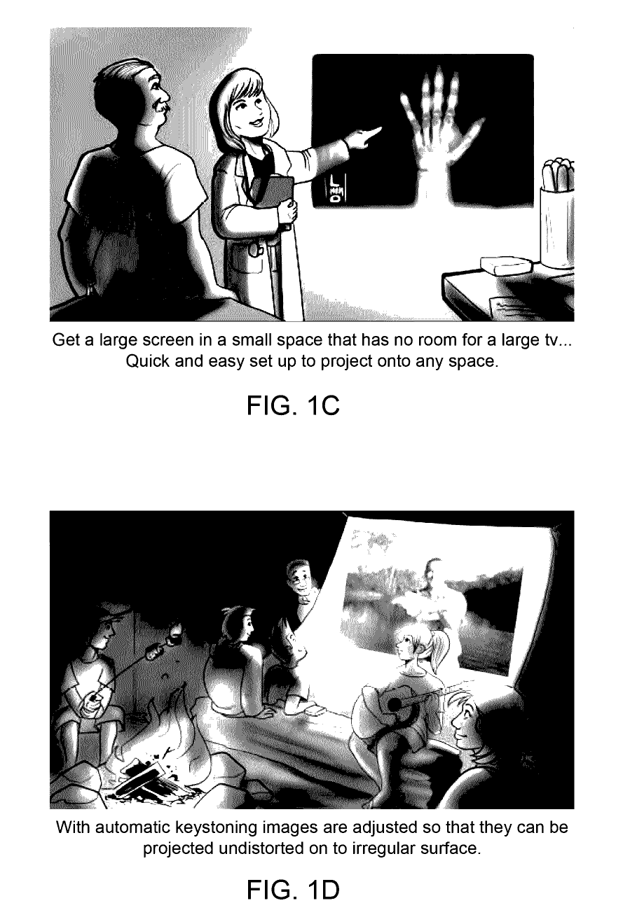

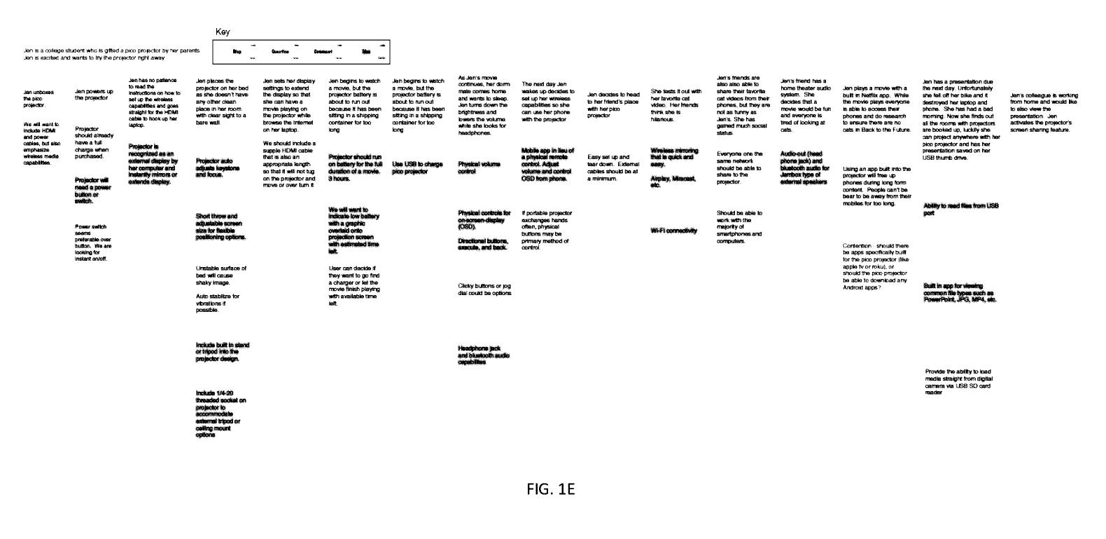

Various different uses of this embodiment are illustrated in the Figures. For example, FIGS. 1A-1D illustrate a pico projector and speaker elements interacting with a mobile hotspot of mobile device to project images and/or video from the mobile hotspot or device onto any large surface. FIG. 1A illustrates how a family can use the projector and speakers to project a movie onto a large surface, such as a wall, providing the family with a real home theater experience complete with a large movie screen. Because embodiments of the invention can be mobile, the family can bring their projector and speakers with on vacation so that they can enjoy their typical entertainment while away from home, such as in a hotel room as shown in FIG. 1B. Embodiments of the invention can also be useful in other applications, such as, for displaying a large image of an x-ray in a doctor's office as illustrated in FIG. 1C. The pico projector can be configured with automatic keystoning so that images can be displayed undistorted on uneven surfaces as illustrated in FIG. 1D. FIG. 1E illustrates various features and accessories associated with different applications of embodiments of the invention.

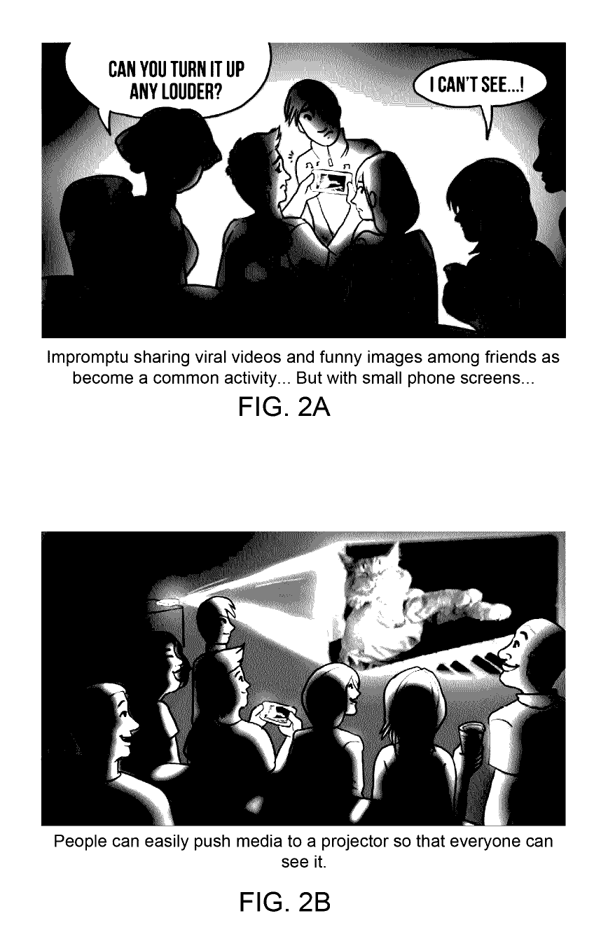

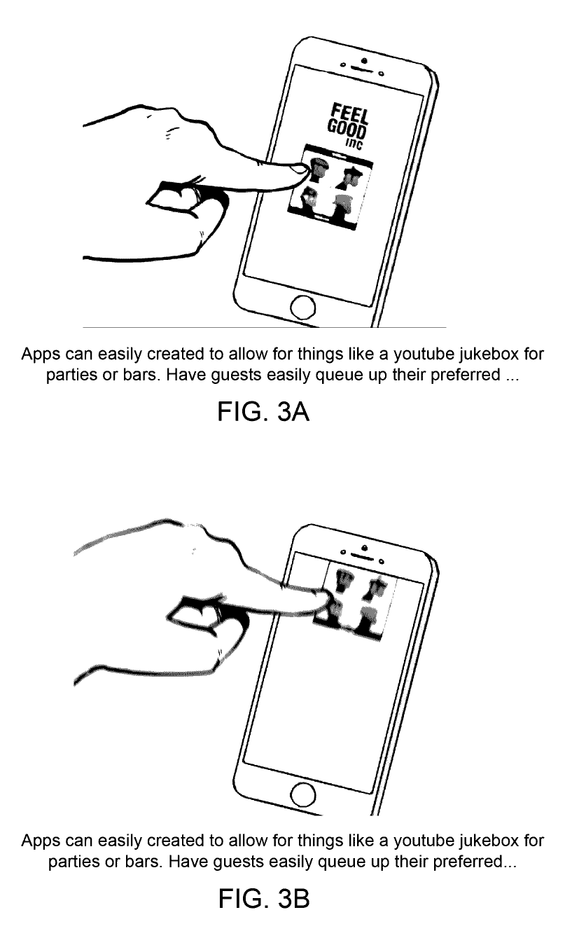

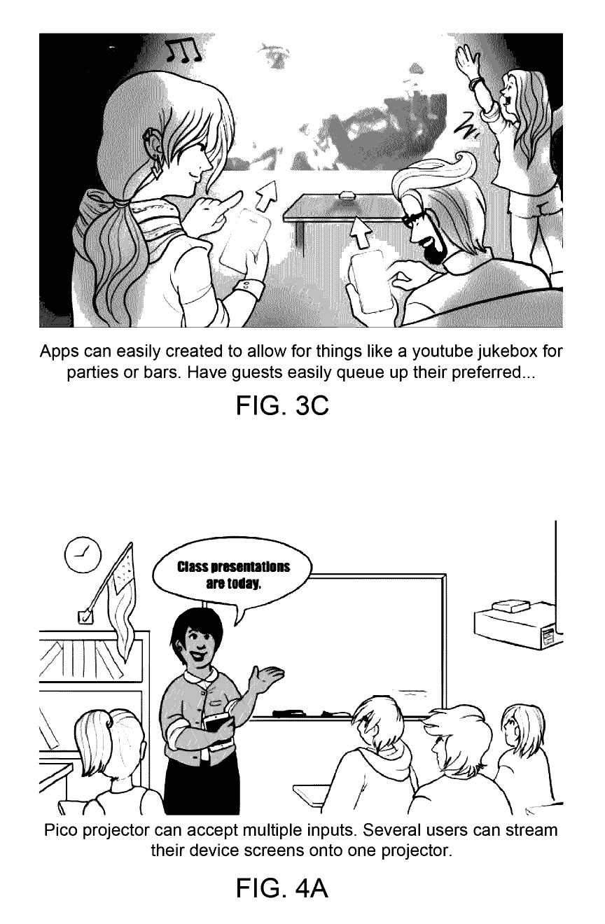

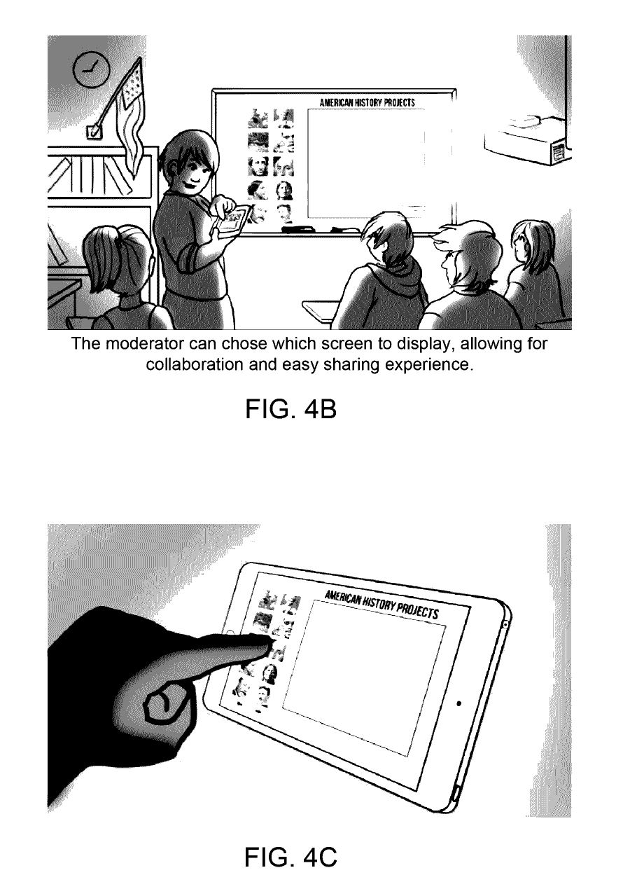

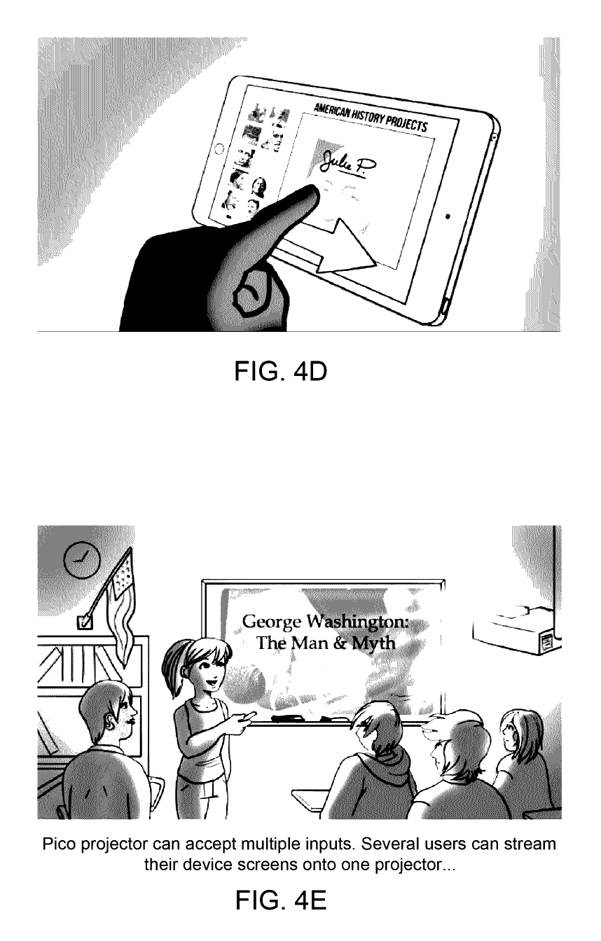

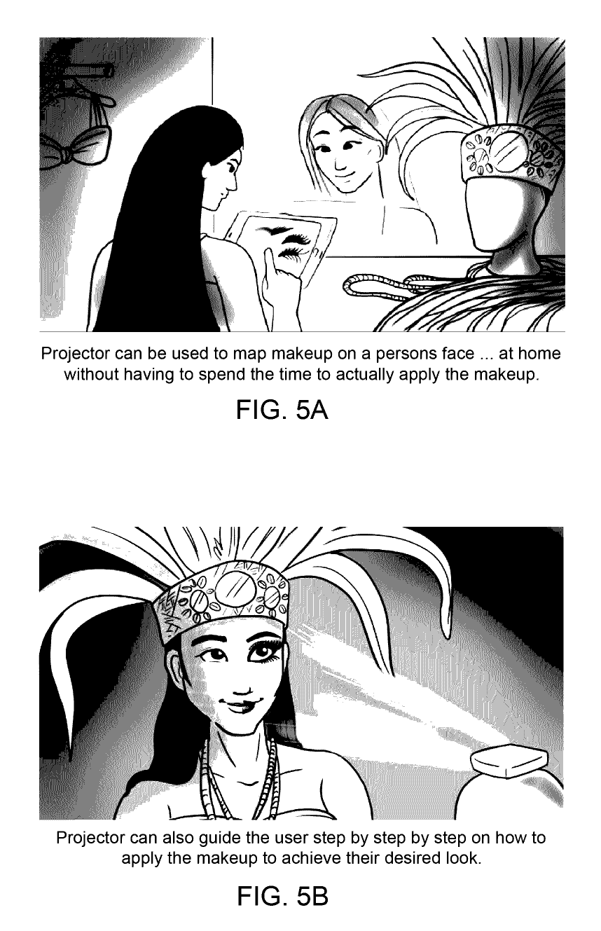

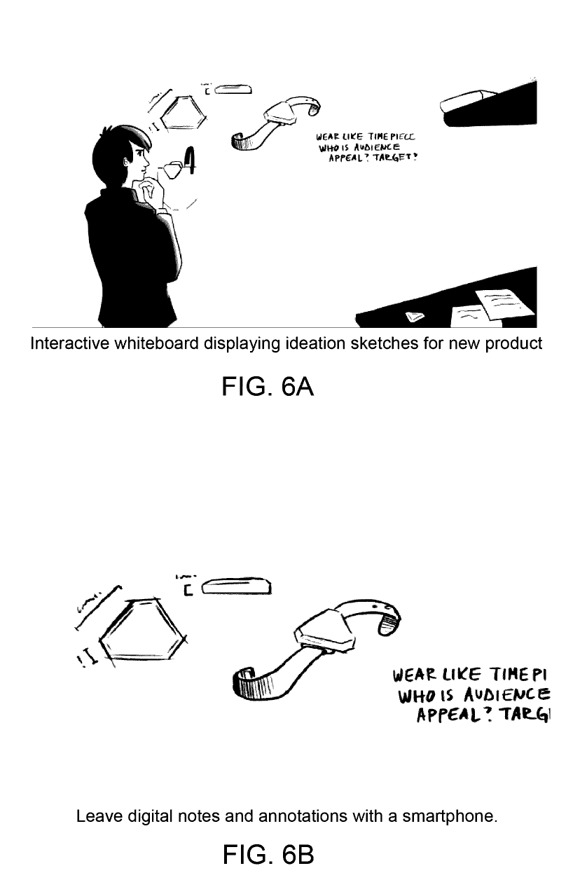

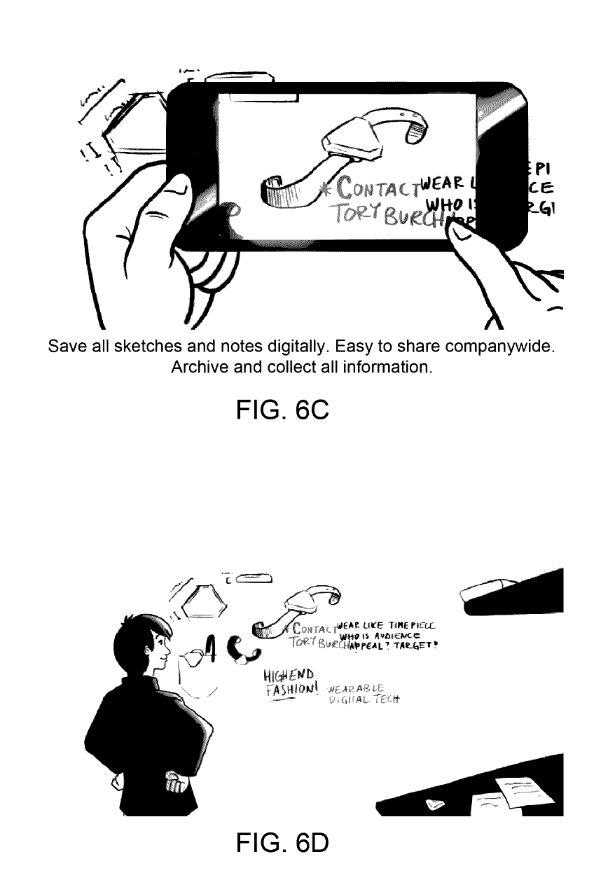

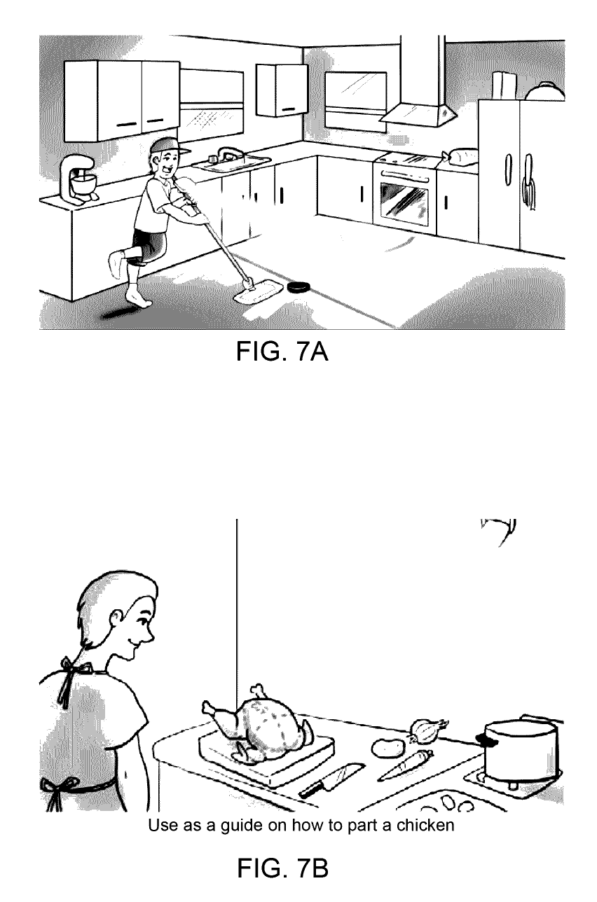

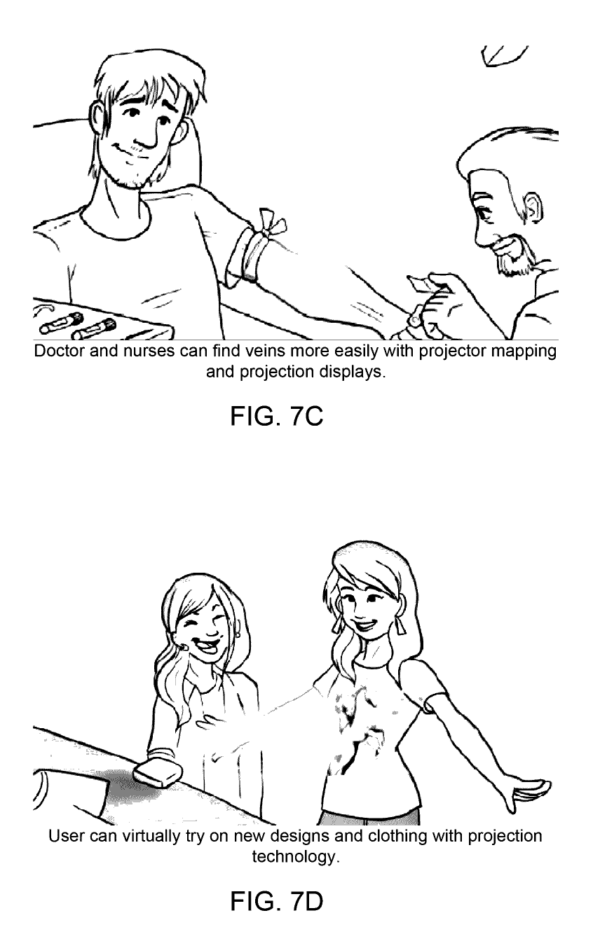

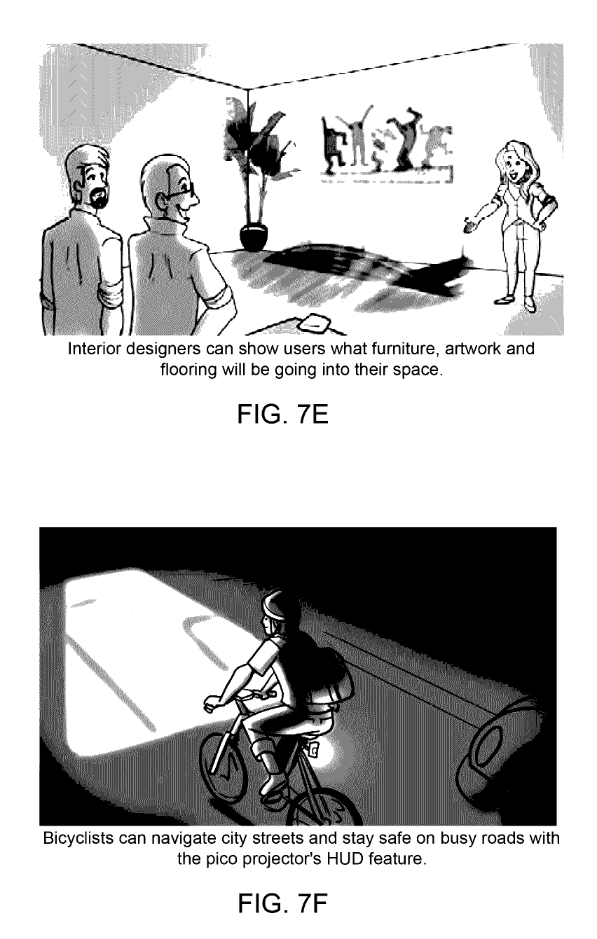

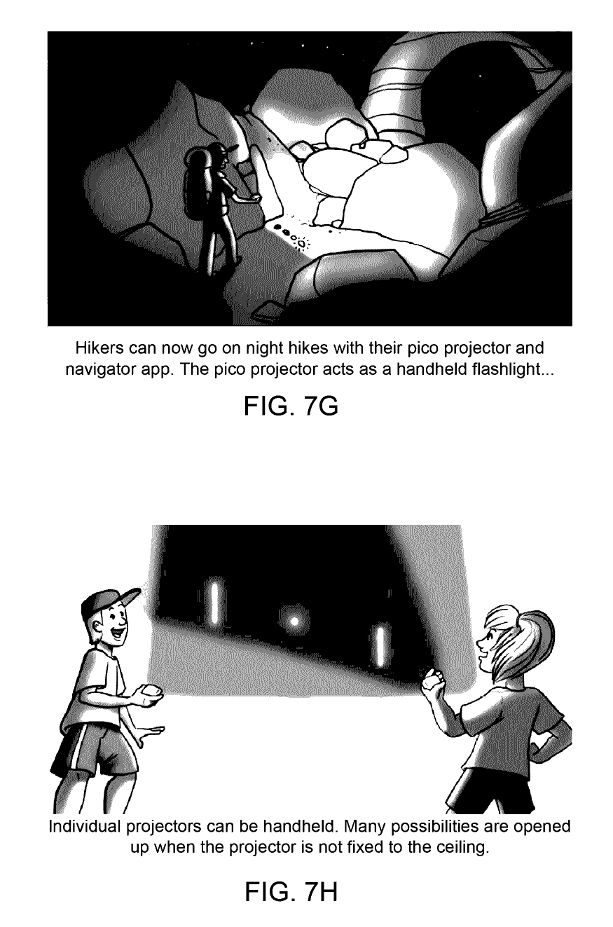

FIGS. 2A-2B illustrate another potential use case for a pico projector and speakers for embodiments of the invention. In this use case, a mobile device user is able to push media from his mobile device to the pico projector so that the media can be easily shared with others. Applications (or apps) can also be designed and used with embodiments of the invention to facilitate cooperation and collaboration between multiple users. For FIGS. 3A-3C illustrate a use case in which an app is used on a mobile device which allow multiple users to queue up media content in the app which can be pushed to the projector and played for everyone. In the case illustrated in FIGS. 3A-3C, a video jukebox app is used to allow multiple users to each queue up their favorite music videos which can be replayed by the projector in a party setting. FIGS. 4A-4E illustrate a scenario in which a presentation app can be used on a mobile device which allows multiple people to collaborate on a presentation which can be pushed to the projector and displayed on a large surface. FIGS. 5A-5B illustrate a use case in which sample makeup schemes can be configured on an app on a mobile device, pushed to the projector, and projected onto a person's face so that the scheme can be previewed on a person before the makeup is actually applied to the person. FIGS. 6A-6d illustrate a use case in which a digital whiteboard app can be used for multiple users to design and comment on a product design. The design and comments can be pushed to the projector and projected on a large surface allowing all collaborators to easily view the design and comments. FIGS. 7A-7H illustrate various other use cases contemplated for various embodiments of the invention.

A pico projector according to various embodiments of the invention can be configured to automatically adapt to the A2Dp compression/decompression cycle. The projector and audio devices can be configured to support a protocol like APTX Low Latency to reduce latency. When paired with variable latency devices, the projector can be configured to auto-correct to maintain proper A/V sync. There is typically an inherent, obvious delay (up to 150+ ms) in the standard Bluetooth A2DP compression/decompression cycle. This delay is usually only tolerable for audio-only application but it is not ideal for video. A predictable, low latency is better suited for video playback applications. Pico projectors according to the subject application can be configured to automatically handle and down convert a full range of audio encodings. If a user connects a 7.1 DRS source, the projection can be configured to immediately down convert the input to stereo without user intervention.

Users are typically not satisfied when they experience a case where the projector isn't able to play audio because it uses a done-convert special encoding. While the device doesn't need to playback these advanced encodings, it preferably should be able to down convert. A pico projector according to the subject application can be configured to automatically handle and down-convert a full range of video encodings—including 4K and 240 hZ+ sources. Basic video settings like brightness contrast, color temperature, and color modes can be made available. Users can also adjust video rotation and toggle between rear/front projection. Embodiments can also be configured to digitally zoom an image produced by the projector. Preferably, user interaction with video settings should be extremely limited. Embodiments of the invention can be configured so that users do not need to adjust video settings on the projector or source device unless they want to do so.

Embodiments of the invention can stackable peripherals (each of which can perform a different function) can include a common form factor with common a connector and connector location, common physical dimensions, common peripheral appearances in terms of colors and textures, common location and selection of magnetics, common location and selection of any latching mechanisms, common location and selection of USB connector, and common location and meaning of indicators so that they are easily stable and so that a user can easily learn where to look and what to look for on these stackable devices. The mechanical features of embodiments of the invention can allow for proper orientation and mating of the accessories, the electrical features can allow for proper power distribution and signaling between accessories, and the software features can define the discovery and configuration of accessories.

The pinout configuration of one embodiment is outlined below:

TABLE 1
Pinouts

| | SIGNAL | |
|---|---|---|
| PIN# | NAME | Description |
| 1 | GND | GND-Contact Resistance can be 25 mohms |
| | | max for connector pin; Current rating can be 3A |
| | | (continuous) min. |
| 2 | I2C_SDA | I2C DATA-3.3 V LOGIC. Bidirectional |
| | | signal. Accessory shall not pull this line low when |
| | | powered off. The signal can conform to the standard |
| | | I2C interface as defined by UM10204, and can |
| | | conform to the modifications defined by the 100 |
| | | KHz SMBus as defined by SMBus Specification |
| | | V3.0. An appropriate series resistor (~500 ohms) |
| | | can be provided for hot insertion protection. |
| 3 | I2C_SCL | I2C CLOCK-3.3 V LOGIC INPUT to |
| | | accessory. Accessory shall not pull this line low |
| | | when powered off. It should be pulled high with a |
| | | 100K resistor |
| 4 | ACC_INT | ACCESSORY INTERRUPT ACTIVE LOW |
| | | OUTPUT, This line should be Tri-stated when there |
| | | is no interrupt and when accessory is powered off. It |
| | | should be pulled hi by a 100K resistor, and protected |
| | | by an appropriate series resistor (~500 ohms) |
| 5 | CHG_EN | CHARGE ENABLE-ACTIVE HIGH |
| | | INPUT-3.3 V LOGIC. This line should be pulled |
| | | high by a 100K resistor. |
| 6 | VBUS | INPUT POWER 4.75 V min −5.5 V max- |
| | | Contact Resistance can be 25 mohms max for |
| | | connector pin; Current rating shall be 3A |
| | | (continuous) min. |

The signaling configuration for one embodiment of the invention is outlined below:

TABLE 2
Signaling Specification

| Number | Requirement | Comments |
|---|---|---|
| Sig-1 | The device can provide common | There is one on the top and one |
| | connectors as described below. | on the bottom |
| Sig-2 | The sample pinout presented | |
| | herein can be supported. | |
| Sig-3 | The 2 wire bus can conform to | 100 KHz seems adequate for |
| | SMBus V2 | this case, and specs get a lot |
| | Supports 100 KHz operation | more complicated at 400 KHz. |
| | Operates at 3.3 V | ARP processing can require |
| | Fully supports ARP functionality | additional software and |
| | Requires a non-persistent slave | hardware, allowing for |
| | address (Non-PSA) | contention to be seen and acted |
| | Requires PEC parity generation | upon. |
| | and processing on all | Non-persistent addresses mean |
| | transmissions and receptions | that it can clear on “power up”. |
| | Presence of signal on the I2S-SCL | Since the battery may be |
| | line shall be considered “power | optional, this uses presence of |
| | up” in the ARP functionality, | I2C-SCL to indicate “power |
| | clearing allocated addresses. | up”. |
| | | PEC is recommended in a hot- |
| | | swap environment. |
| Sig-4 | The accessory can draw power | Power draw from the VBUS |
| | from VBUS in the following scenario: | line can be directly under control of |
| | CHG_EN is high | the mobile hotspot. It can be pulled |
| | VBUS is above 4.75 V | high on each accessory so they will |
| | The device has NOT been sent a | charge when no mobile hotspot is |
| | command to disable charging | present, and pulled low on the mobile |
| | | hotspot so that a dead mobile hotspot |
| | | can receive all VBUS power. |
| Sig-5 | The accessory can be capable of | This signal is not really needed, |
| | asserting the ACC_INT signal, when a | but is being provided to cover |
| | pre-defined and agreed upon event | future contingencies. |
| | requires notification of the mobile | The mobile hotspot should be |
| | hotspot bus master. | polling for ARQ at least at 10 |
| | At this time, it will be asserted on | sec intervals. |
| | connection of the device to the | This will allow responses to be |
| | mobile hotspot, as determined by | much faster, hopefully within 1 |
| | presence of signal on the I2S-SCL | sec of the SMBus being |
| | line. | available. |
| | Additional functionality may be | |
| | defined in the future. | |
| Sig-6 | The device can be capable of | |
| | communicating on the SMBus within | |
| | 500 ms of detection of signal on the | |
| | I2S-SCL line. | |
| Sig-7 | The device can be configured to | |
| | draw no more than 500 mA of current | |
| | from the VBUS line. | |
| Sig-8 | The device can have a micro USB | The local USB should be in the |
| | plug, located as specified herein | same locations for all devices, and is |
| | This can support charging the | used for local power and local |
| | device battery and communication | communications only. |
| | with the device. | |
| | The device battery, and the USB | |
| | plug will not support charging of | |
| | the VBUS power line. | |
| Sig-9 | INFORMATIONAL: | This should allow us to register |
| | The mobile hotspot may perform | devices within 1 sec of |
| | the following functions in terms of | connection |
| | ARQ functionality: | The addresses can be be |
| | An ARQ will be sent every 10 sec | assigned to the devices in order |
| | to see if new devices are present. | of connection. |
| | If ACC_INT is asserted, the | If multiple devices are |
| | mobile hotspot will immediately | connected at once, they are |
| | perform an ARQ. | assigned addresses in order of |
| | Through the ARQ protocol, the | UDID. |
| | mobile hotspot will assign | If more than 8 devices request |
| | addresses, starting at the lowest | an address, they will be given |
| | UDID and continuing to the | addresses, but denied access to |
| | highest UDID. | VBUS and not enabled for use |
| | If there are more than 8 devices, | by the mobile hotspot. |
| | addresses will continue to be | |
| | powered up, but will be told to | |
| | disconnect from VBUS, and will | |
| | not be enabled for use by the | |
| | mobile hotspot | |

The software specification for one embodiment of the invention is provided below: This section specifies a software interface which may be used to configure and to maintain the stackable peripheral accessories. The basic philosophy is:
All transfers can be performed by block transfers with PEC. These can be automatically made longer as more data is available, so to some degree, functionality can be added incrementally.
At this time, only 2 command codes are defined although 128 are available, so more can be used in the future.
There can be a READ block presented at a known command code (0x01) that presents the device type identity (UTF8) and a bitmask of device capabilities.
There can be a second READ block presented at a known command code (0x02) that presents device configuration and status.
There can be a WRITE block presented at a known command code (0x02) that accepts configuration information.

With respect to discover, the stackable peripherals may use ARP protocol of SMBus which are described in more detail herein. With respect to device ID:

| Number | Requirement | Comments |
|---|---|---|
| Sw-1 | The device can provide device ID | The (0) indicates a read. |
| | information at Command Code | Block format automatically |
| | 0000 001 (0) b consisting of | adjusts length to accommodate |
| | UTF8 representation of device name, | all data. |
| | between 0 and 50 characters, ending | PEC provides error detection, |
| | in <EoTxt> (0x03) | and mobile hotspot may have |
| | Bitmask of capabilities | to request a retransmission. |
| | b0-WiFi | Device name should be |
| | b1-Bluetooth | uniquely defined by us |
| | b2-Projector | |
| | b3-Speaker | |
| | b4-Battery Charger | |
| | Filled with “0” to complete | |
| | byte | |
| Sw-2 | The device may provide device | The (0) indicates a read. |
| | configuration and status for each capability | This approach allows for each |
| | independently. The Command Code at | capability to be independently |
| | which the capability is located can be 0000 | read and configured without an |
| | 010 (0) b for the first capability, 0000 011 | arbitrarily long number of |
| | (0)b for the second capability, . . . , where | command codes. |
| | the format of capabilities is described below. | |
| Sw-3 | The device may provide the ability to | The (1) indicates a read. |
| | configure each capability independently, | |
| | by receiving a block write at the Command | This approach allows for each |
| | Code corresponding to the capability bit | capability to be independently |
| | mask. The Command Code at which the | read and configured without an |
| | first capability is configured is located at | arbitrarily long number of |
| | 000 010 (1) b, 0000 0011 (1) b for the | command codes. |
| | second capability, . . . , where the format | |
| | of capabilities is described below. | |
| Sw-4 | The accessory may draw power from | Power draw from the VBUS |
| | VBUS only in the following scenario: | line is directly under control of the |
| | CHG_EN is high | mobile hotspot. It's pulled high on |
| | VBUS is above 4.75 V | each accessory so they will charge |
| | The device has NOT been sent a | when no mobile hotspot is present, |
| | command to disable charging | and pulled low on the mobile hotspot |
| | | so that a dead mobile hotspot will |
| | | receive all VBUS power. |
| Sw-5 | Bluetooth Configuration shall be: | |
| | Bluetooth Friendly Name <EOTxt> | |
| | Discoverable (1 bit) | |
| | Connectible (1 bit) | |
| | Send URCs (1 bit) | |
| | Start Bluetooth (1 bit) | |
| | Start BT in Test Mode | |
| | Start BT in pass-through mode | |
| | Start BT in HCI mode | |
| | Start BTLE | |
| | Clear persistent Bluetooth data | |
| | Delete BT Local Keys | |
| | Delete bonded device database | |
| | Delete GATT database | |

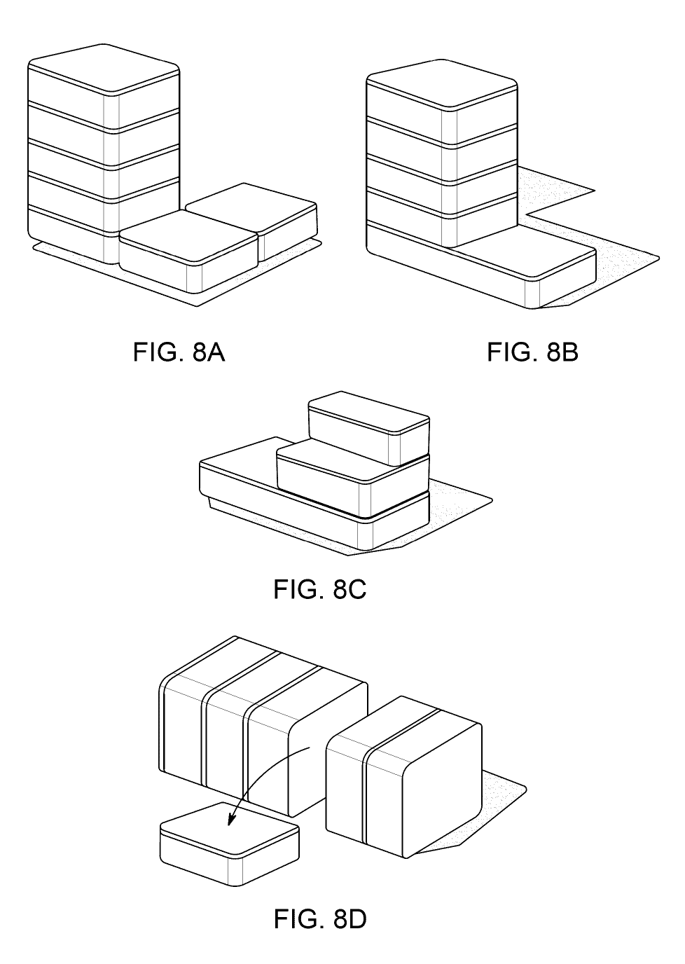

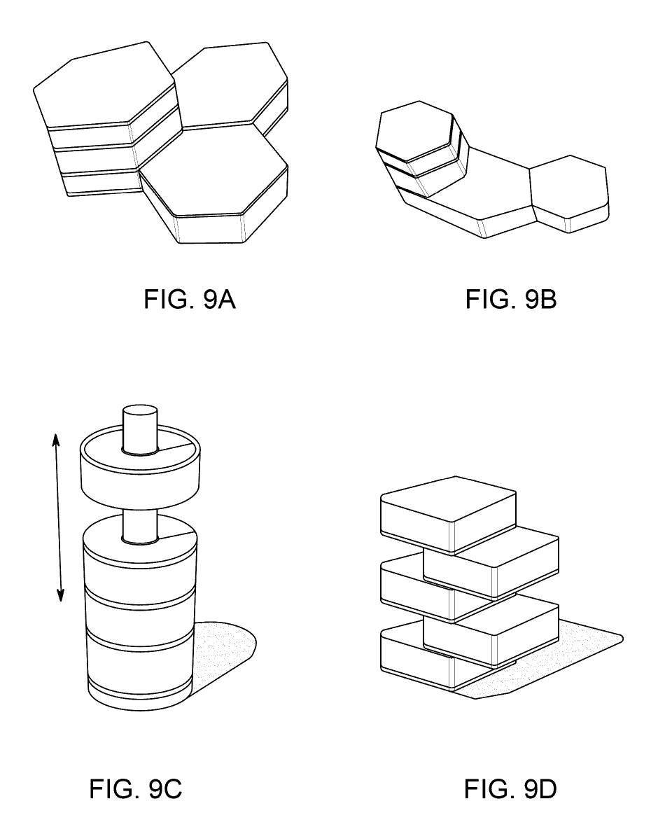

It is contemplated that the peripheral devices will be stackable. A number of different stackable configurations have been contemplated. Several embodiments of stackable configurations are illustrated in the figures. For example, FIGS. 8A-8D illustrate a generally square-shaped set of peripherals which can be stacked in various different ways. FIGS. 9A-9B illustrate stackable peripherals having a hexagonal shape, FIG. 9C illustrates donut-shaped stackable peripherals, and FIG. 9D illustrates the square-shaped peripherals of FIGS. 8A-8D stacked in an alternative arrangement.

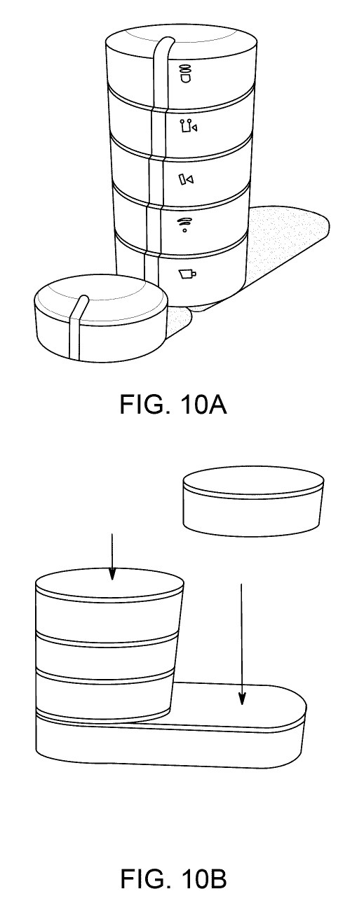

FIGS. 10A-10B illustrate generally circular-shaped stackable peripherals 100. As shown in FIG. 10A, LEDs 102 can be used to indicate the status, etc. of each individual peripheral. The peripherals can be configured so that the LEDs 102 all line up when the peripherals are in a stacked position. In this manner, it is easy for the user to find and identify the status of each individual peripheral. FIGS. 11A-11D illustrate some of the connector details and design of various embodiments of peripherals 110 designed in according with various aspects of the invention. In this embodiment, the top of each peripheral includes a recess 112 configured to mate with a protrusion 114 on the bottom of another peripheral 110. Electrical contacts 116 can be hidden deep in the recess 112 in a location which mates with contacts 118 in the protrusion 114 of another peripheral 110. In this manner, the peripherals 110 mate with each other in a stackable manner and are electrically connected to each other through the electrical contacts 116 and 118.

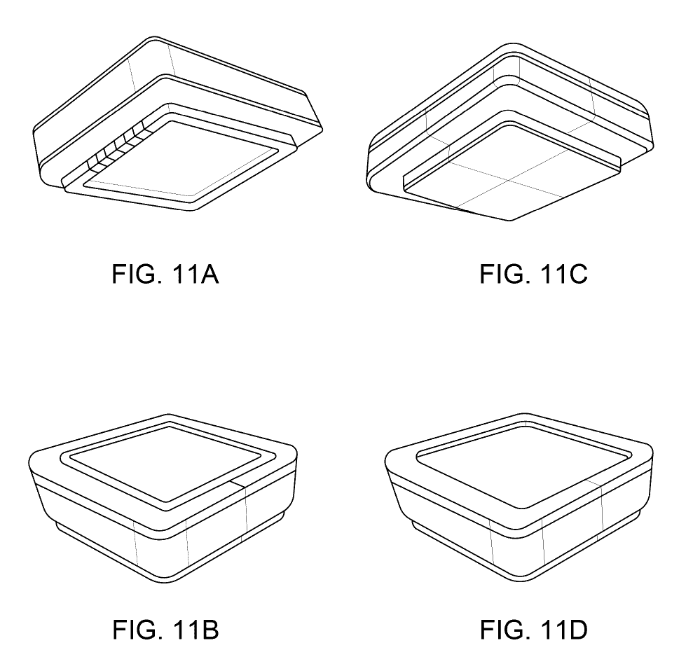

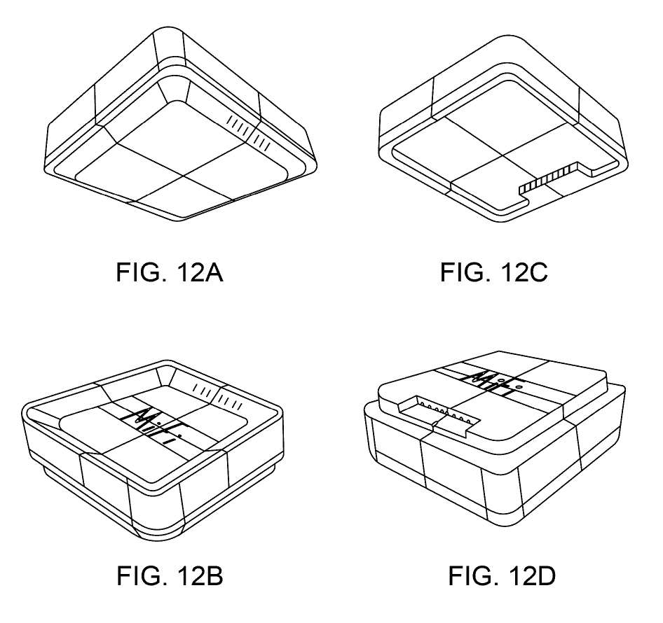

FIGS. 12A-12B illustrate a generally square peripheral 120 having a beveled edge 122 in its protrusion 124 in which the electrical contacts 126 are located so that the contacts 126 do not touch the surface of a table or other structure onto which the peripheral 120 may be placed. The corresponding edges of the recess 128 in the top of the peripheral 120 can also be beveled to mate with the beveled edge 122 of the protrusion 124. In FIGS. 12C-12D, the top of a peripheral 130 can include a trap door 132 which can protect the contacts when the peripheral 130 is not mated with another peripheral 130. The bottom of each peripheral 130 can include a contact block 134 which is configured to push down the trap door 132 so that the contacts hid by the trap door 132 are exposed and can mate with contacts in the contact block 134.

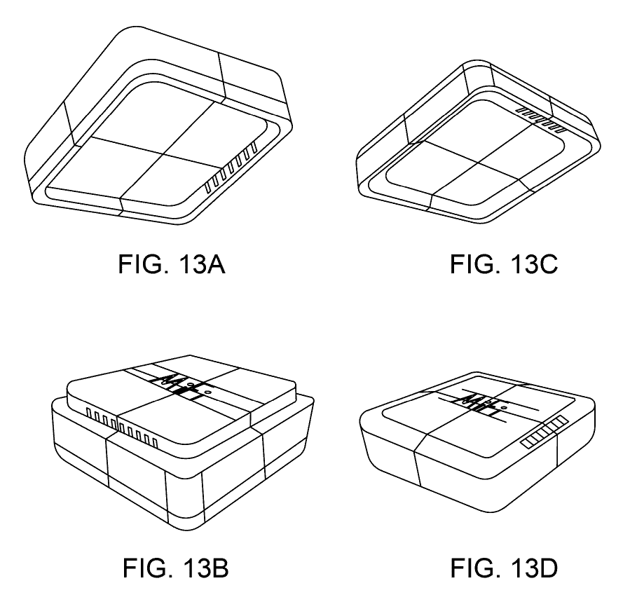

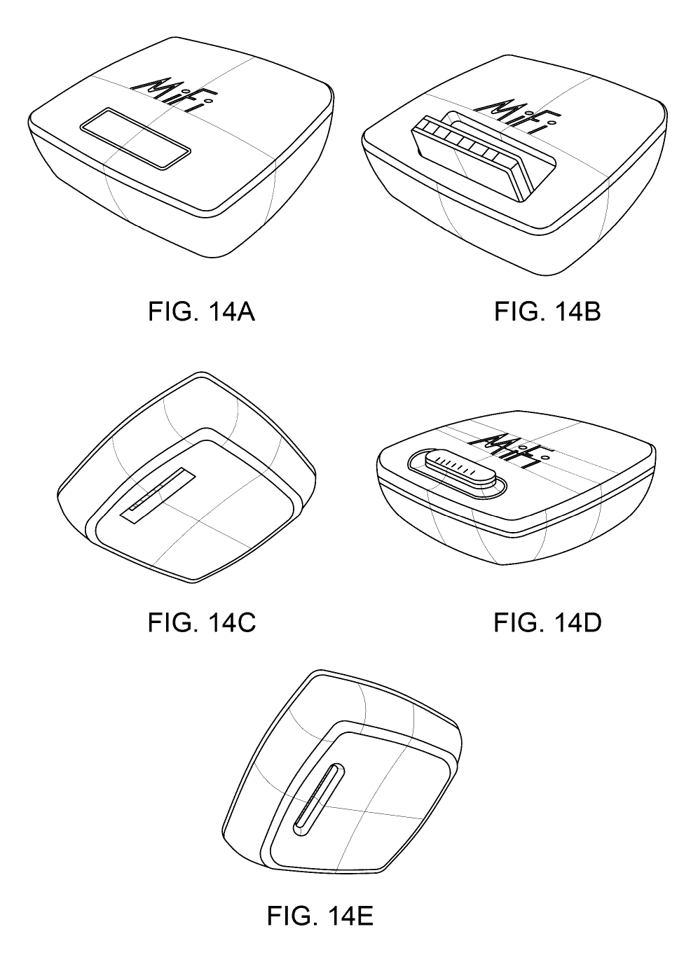

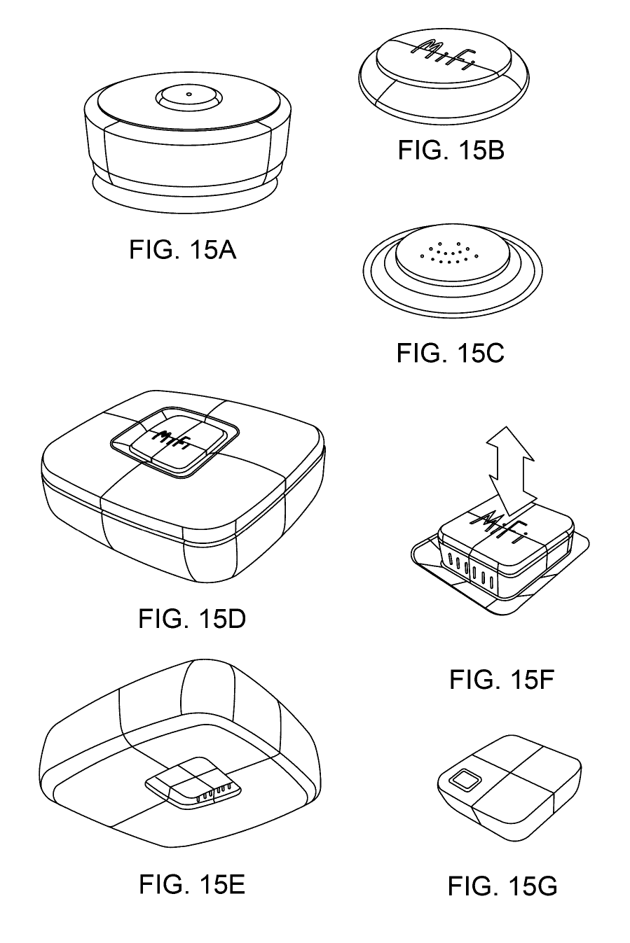

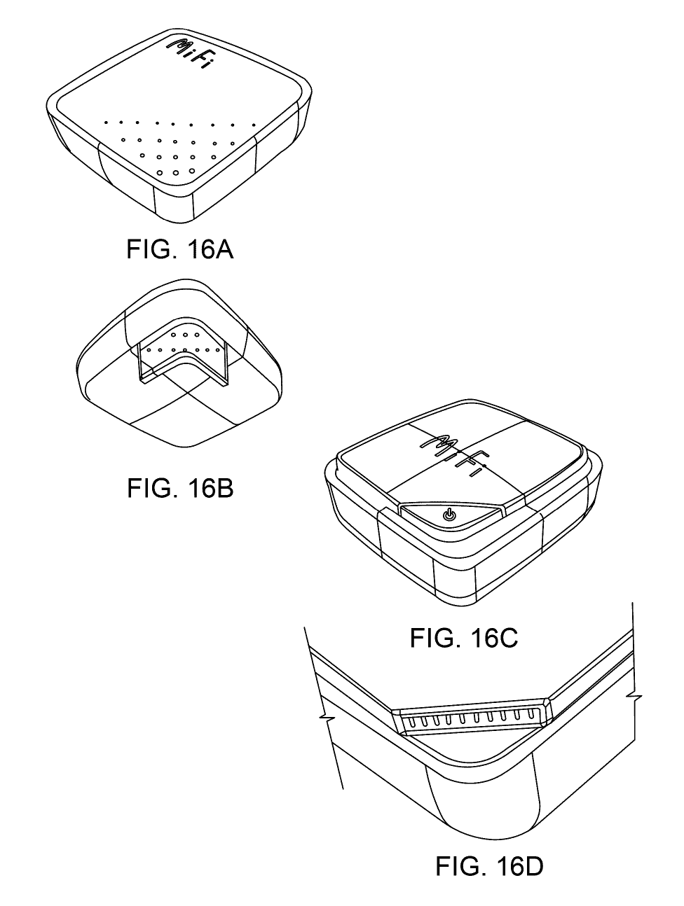

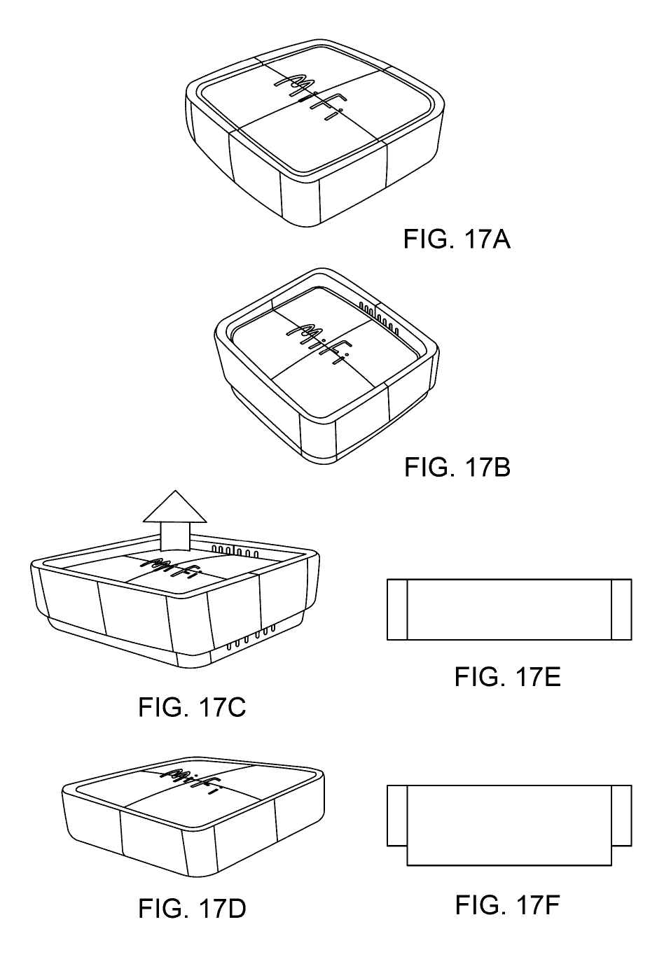

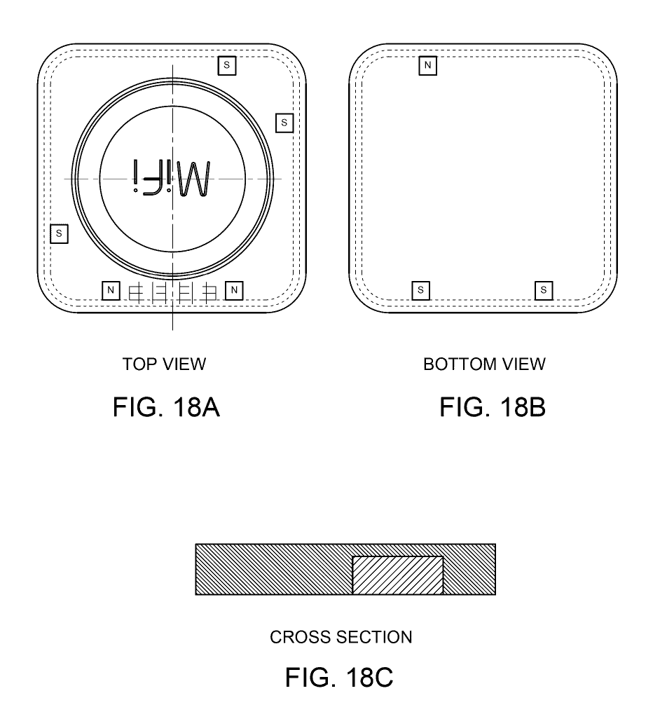

FIGS. 13A-13B illustrate alternative embodiments of the peripherals 140 of FIGS. 11A-11D. In FIGS. 13A-13B, the recess 142 and protrusions 144 are reversed so that the top of each peripheral includes the protrusion 144 and the bottom of each peripheral 142 includes the corresponding recess. Similarly, FIGS. 13C-13D illustrate an alternative peripheral 150 embodiment of FIGS. 12A-12D with the protrusions 152 and recesses 154 similarly reversed. FIGS. 14A-14C illustrate an embodiment of peripheral 160 in which the contact block 162 can be configured to rotate. In the unmated position, the contact block 162 is rotated to protect the contacts (see FIG. 14A) while in the mated position, the contact block 162 is rotated to expose the contacts so that they can mate with contacts in another peripheral 160 (see FIG. 14C). FIGS. 14D-14E illustrate a similar alternative embodiment as that shown in FIGS. 14A-14C, however, in the peripherals 170 illustrated in FIGS. 14D-14E, the contact block 172 is fixed (i.e. it does not rotate). This is a simpler and generally less expensive design than that illustrated in FIGS. 14A-14C, however, the contact in this embodiment remain exposed at all times which may lead to damage. Similar alternative embodiments are illustrated in FIGS. 15A-15G, 16A-16D, and 17A-17F. FIGS. 18A-18C illustrate top, bottom, and cross-sectional side views of one embodiment of peripheral designed in accordance with the present invention.

1. A stackable electronic device, comprising:
a first set of contacts on one side of the device;
a second set of contact on another side of the device; and
a connection mechanism;
wherein the first set of contacts is configured to mate with a corresponding first set of contacts on another stackable electronic device and wherein the second set of contacts is configured to mate with a corresponding second set of contacts on another stackable electronic device when the stackable electronic device is stacked upon or under another stackable electronic device providing an electrical connection between the stackable electronic device and the another stackable electronic device and wherein the connection mechanism is configured to secure the stackable electronic device and the another stackable electronic device together when stacked.

2. The stackable electronic device of claim 1, wherein the first set of contacts of the stackable electronic device is placed in a location on the stackable electronic device in a location common to a location of the corresponding first set of contacts on the another stackable electronic device when the stackable electronic device and the another stackable electronic device are stacked together.

3. The stackable electronic device of claim 1, wherein the second set of contacts of the stackable electronic device is placed in a location on the stackable electronic device in a location common to a location of the corresponding second set of contacts on the another stackable electronic device when the stackable electronic device and the another stackable electronic device are stacked together.

4. The stackable electronic device of claim 1 further comprising status indicators, wherein the status indicators are placed in a location on the stackable electronic device in a location common to a location of corresponding status indicators on the another stackable electronic device when the stackable electronic device and the another stackable electronic device are stacked together.

5. The stackable electronic device of claim 1, wherein the stackable electronic device is capable of automatically configuring addressing and device capabilities when mated with the another stackable electronic device.

6. The stackable electronic device of claim 1, wherein the stackable electronic device is capable of automatically configuring a wireless communication path with a wireless communication device near the stackable electronic device.
